(19) United States
(12) Patent Application Publication
(10) Pub. No.: US 2008/0277502 A1
(43) Pub. Date: Nov. 13, 2008

(54) Modular Nozzle System for Generating Drops from Liquids of Different Viscosity

(76) Inventor: Rainer Pommersheim, Mainz (DE)

Correspondence Address: BODNER & O'ROURKE, LLP, 425 BROADHOLLOW ROAD, SUITE 108, MELVILLE, NY, 11747, US

(21) Appl. No.: 11/597,243

(22) PCT Filed: Mar. 4, 2005
(86) PCT No.: PCT/EP2005/002323

§ 371 Date: Sep. 13, 2007

(30) Foreign Application Priority Data
May 28, 2004 (DE) 10 2004 026.725.1

(51) Int. Cl. B05B 7/08

(52) U.S. Cl. 239/423; 239/418

(57) ABSTRACT

The invention relates to a nozzle system of modular construction, by means of which drops may be produced from liquids of different viscosity. The heart of the invention is constituted of multiple arrangements of individual nozzles without moving parts, which are in connection with one another and form individual modules. This construction enables a simple expansion and adaptation of the system, which ensure a maximum flexibility.

The invention relates to a nozzle system of modular construction, by means of which drops may be produced from liquids of different viscosity. The heart of the invention is constituted of multiple arrangements of individual nozzles without moved parts, which are in connection with one another and form individual modules. This construction enables a simple expansion and adaptation of the system, which ensure a maximum flexibility.

In the technological practice, it is often necessary to produce individual drops from different liquids. The most simple and most popular method of achieving this is spraying by means of suitable nozzles. Such nozzles are commercially available in a very wide design variety. The range extends from a simple shower head or lawn sprinkler to the high technology developments in the field of mechanical engineering or dyes and paints. All these systems are designed in such a manner that they generate a spray fog or at least a spray jet which consists of innumerable drops which, however, may neither be influenced individually nor defined more closely.

If it is desired, however, to generate precisely defined drops in order to obtain spherical particles by chemical or physical hardening, the above-mentioned systems are useless due to their inaccuracy with respect to the generated individual drops. For such purposes, arrangements are employed which are capable of producing precise liquid jets which are subsequently broken up into individual drops of defined sizes.

In all these systems, the liquid jets are generated by pressing the liquid basic materials through capillary openings. Differences may be found only in the methods by which these jets are broken up into individual drops.

The methods may be classified into two major groups:
1. Methods wherein the liquid jet besides being subjected to an axial motion, additionally experiences other motions such as rotation or vibration; and
2. methods wherein the liquid jets besides its axial flow motion is not subjected to any additional motion.

In the first category, the jet is broken up by centrifugal forces or resonance vibrations, respectively, in the second category by the application of additional media, generally in the gaseous phase. The present invention joins the second group.

In the reference literature, systems may be found at many places, which are employed for the generation of individual drops from liquids by means of capillaries. In the following, only two representative systems will be mentioned.

### 1. The Two-Component Nozzle

F. Lim and A. Sun describe e.g. in the magazine “Science”, No. 210, pages 908 to 910, vol. 1980, a nozzle wherein the drops of a liquid jet which is pressed through a capillary are separated by a concentrically guided air stream. In this manner, drop sizes ranging from approx. 200 μm and approx. 2 mm with a very close size distribution are obtained. This publication deals, however, primarily with a laboratory set-up of a very low throughput, which is completely unsuitable for technical applications.

### 2. The Vibration Nozzle

Another method for producing drops is the one described in patent application DE 3836894.Here, several capillaries are made to vibrate which leads to a breakup of the liquid jet into individual drops. The obtained drops again have diameters ranging from approx. 200 μm and approx. 2 mm, with the productivity being considerably higher than with the above-mentioned nozzles, but with a very much wider size distribution. The system necessitates a readjustment for each new application because the resonance frequency for the drop separation has always to be set anew. Presently, technical methods are available which function to the above principle. The German company BRACE, at Alzenau near Frankfort/Main, for example, offers such systems for industrial applications.

Given this situation, the invention is based on the object to specify a nozzle system which due to its modular construction is capable of producing drops from liquids of different viscosity in a wide range of sizes with a close distribution in such quantities as are suitable for a technical production. The system operates to the principle of the two-component nozzle and does therefore not need any moved parts or cumbersome adjustments of the parameters for the drop generation.

According to the invention, the system consists of so-called individual heads (Einzelköpfe; EK) which may be joined to individual arrangements (Einzelanordnungen; EA). These individual arrangements may in turn be combined to form so-called multiple arrangements (Mehrfachanordnungen; MA). Each of these multiple arrangements itself may similarly be an individual arrangement in a still larger multiple arrangement. In this manner, the nozzle system may be expanded as required, without any fundamental change in the physical or fluidic condition in the system itself. The individual components are in their majority lathe works which may be manufactured from suitable materials such as stainless steel, synthetic materials, ceramic materials, and the like. The nozzles may be heated and are thus suited not only for dripping of solutions but also for melting.

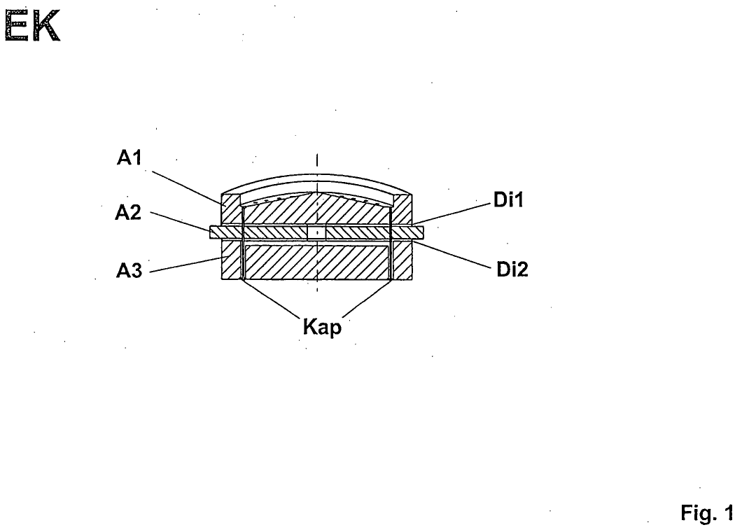

FIG. 1 shows the construction of an individual head (EK) which forms the basic modular unit of the nozzle system. Such an individual head may be employed both alone as well as in a composite assembly with other individual heads. When it is employed alone, the head has to be closed at its upper side by a suitable cover plate which is to be added to the construction of FIG. 1. This plate creates a closed chamber in the upper portion of A1 and carries the connections for the liquid and the gas.

Actually, the individual head is a multiple arrangement of so-called two-component nozzles. These may be, for example, 4, 8, 16, 32, etc. individual nozzles. The operation principle of the two-component nozzle is known in the literature. According to the invention, they have, however, been modified in such a manner that the individual two-component nozzles within an individual head are in communication with one another via common channels for the fluid and for the gas. Thereby, additional supply lines are prevented, which enhances the reliability and the maintenance comfort.

The individual head consists of the following major components:
A manifold body A1 for the fluid with incorporated capillaries Kap;
a separating plate A2 through which the capillaries extend and the gas is supplied;
a manifold body A3 for the fluid with outlet openings for the gas and the liquid-carrying capillaries;
seals Di1, Di2, etc.

The parts are mutually screwed so that the individual head may easily be disassembled. It works as follows:

The material to be dripped is transferred via suitable supply lines into the manifold chamber of the body A1. This may be done e.g. by means of pressure or by pumping. In any case, it must be ensured that the liquid is supplied to the head in a uniform flow. In the interior of the chamber, the liquid is distributed to the individual capillaries and pressed through same by the pressure prevailing therein. Thereby, a liquid jet is generated from each capillary at the lower nozzle end.

A gas is simultaneously fed into the manifold chamber of the body A3 via a channel in the wall of the head and via an opening in the separating plate A2. The liquid-carrying capillaries are arranged in the centre of the outlet openings. In this manner, a concentric air stream is generated at each capillary. This air stream causes a defined separation of drops, with the drop size being in inverse ratio to the air stream.

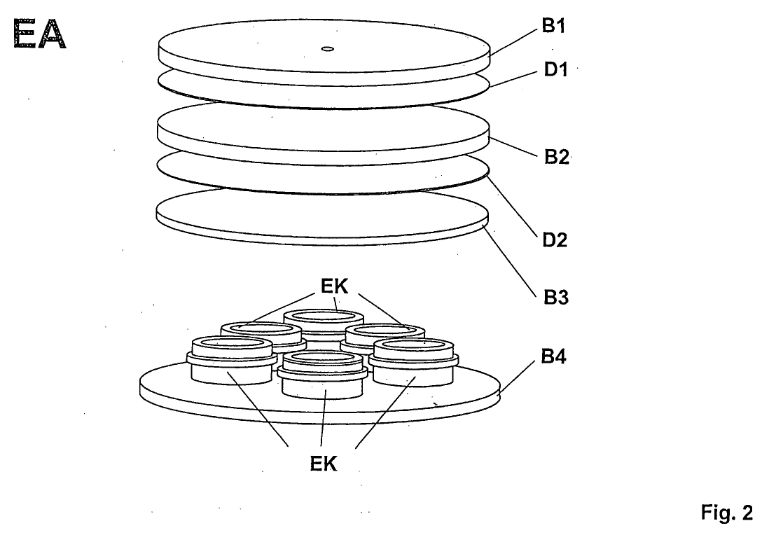

FIG. 2 shows how the individual heads from FIG. 1 may be joined to an individual arrangement (EA). An individual arrangement may, for example, include 4, 6, 8, etc. individual heads. An individual arrangement consists of the following parts:
A cover plate B1 which carries the connections for the liquid and the gas;
a manifold plate B2 with channels for the liquid and the gas being milled into the upper and lower side;
a cover plate B3 for the individual heads with suitable openings for the liquid and the gas;
seals D1, D2;
a base plate B4 for supporting the individual heads EK.

The individual arrangement EA works as follows:

The liquid and the gas are supplied to the channels in the manifold plate B2 via the connections in the cover plate B1. These channels are arranged radially, guide these two media to the appropriate locations of the individual heads, and distribute them uniformly to all individual heads. Corresponding holes in the cover plate B3 ensure that both the liquid and the gas reach the intended locations of the individual heads. In this manner, the individual heads are supplied as desired and are able to function as described with reference to FIG. 1.

The base plate B4 serves to support the individual heads EK and to secure the individual arrangement EA on the base plate of a multiple arrangement or in a machine.

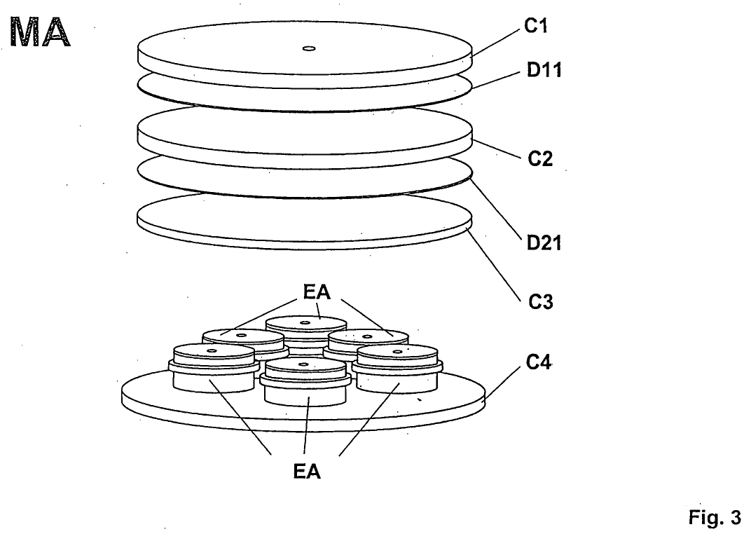

FIG. 3 illustrates a multiple arrangement. Basically, it is constructed as the individual arrangement shown in FIG. 2 and operates in the same manner. The only difference from the individual arrangement is that the individual heads EK have been replaced here by entire individual arrangements EA.

Thus, the multiple arrangement consists of:
A cover plate C1 which carries the connections for the liquid and the gas of a manifold plate C2, with channels for the liquid and the gas being milled into the upper and lower side;
a cover plate C3 for the individual heads with suitable openings for the liquid and the gas;
seals D11, D21;
a base plate C4 for supporting the individual arrangements EA.

The multiple arrangement MA works similar to the individual arrangement EA:

The liquid and the gas are supplied to the channels in the manifold plate C2 via the connections in the cover plate C1. These channels are arranged radially, guide these two media to the appropriate locations of the individual arrangements, and distribute them uniformly to all individual arrangements. Corresponding holes in the cover plate C3 ensure that both the liquid and the gas reach the intended locations of the individual arrangements. In this manner, the individual arrangements are supplied as desired and are able to function as described with reference to FIG. 2.

The base plate C4 serves to support the individual arrangements EK and to secure the multiple arrangement MA on the base plate of a larger multiple arrangement or in a machine.

1. A modular nozzle system for the dripping of liquids of different viscosity, which consists of several specially arranged capillaries though which the liquid to be dripped is pressed and at whose outlet openings the separation of drops is effected via an air stream which is directed concentrically to the individual capillaries,
characterised in that
the capillaries are grouped in so-called individual heads and are in communication with one another.

2. The modular system for the dripping of liquids of different viscosity according to claim 1,
characterised in that
the individual heads are constructed in accordance with FIG. 1 and comprise several of the following components:
A manifold body with a chamber of the liquid to be dripped with capillaries;
capillaries which are arranged radially;
a separating plate with opening for the gas and tubes for the capillaries;
a manifold body for the gas with outlet openings for the gas and the capillaries;
seals.

3. The modular system for the dripping of liquids of different viscosity according to claim 2,
characterised in that
the capillaries are communicating with one another in the interior of the individual heads and the gas outlet openings in the centre of which the capillaries are located are also connected by channels with one another.

4. The modular system for the dripping of liquids of different viscosity according to claim 1,
characterised in that
the individual heads may be combined to so-called individual arrangements which are constructed, arranged, and/or connected with one another in accordance with FIG. 2 and comprise several of the following components:
A cover plate with connections for the liquid to be dripped and the gas;
a manifold plate with channels for the liquid to be dripped and the gas;
a cover plate for the individual heads with corresponding holes for the liquid to be dripped and the gas;
a base plate for supporting the individual heads;
seals.

5. The modular system for the dripping of liquids of different viscosity according to claim 4,
characterised in that
the individual arrangements may be joined to so-called multiple arrangements which are constructed, arranged, and/or connected with one another in accordance with FIG. 3 and comprise several of the following components:
A cover plate with connections for the liquid to be dripped and the gas;
a manifold plate with channels for the liquid to be dripped and the gas;
a cover plate for the individual heads with corresponding holes for the liquid to be dripped and the gas;
a base plate for supporting the individual arrangements;
seals.

6. The modular system for the dripping of liquids of different viscosity according to claim 5,
characterised in that
the multiple arrangements in turn may be included as individual arrangements in a still larger multiple arrangement.

7. The modular system for the dripping of liquids of different viscosity according to claim 1,
characterised in that
the generated drops may be chemically precipitated, e.g. by the influence of salts.

8. The modular system for the dripping of liquids of different viscosity according to claim 1,
characterised in that
the generated drops may be physically precipitated, e.g. by temperature changes.

9. The modular system for the dripping of liquids of different viscosity according to claim 8,
characterised in that
the precipitated drops include material to be immobilised.

10. The modular system for the dripping of liquids of different viscosity according to claim 7,
characterised in that
the precipitated drops include material to be immobilised.
